(19) United States
(12) Patent Application Publication
(10) Pub. No.: US 2006/0237486 A1
(43) Pub. Date: Oct. 26, 2006

(54) Discharge valve provided with a sack

(76) Inventor: Olaf Kersten, Krefeld (DE)

Correspondence Address: WALL MARJAMA & BILINSKI, 101 SOUTH SALINA STREET, SUITE 400, SYRACUSE, NY, 13202, US

(21) Appl. No.: 10/524,160

(22) PCT Filed: Aug. 7, 2003
(86) PCT No.: PCT/EP03/08785

§ 371 Date: Mar. 10, 2006

(30) Foreign Application Priority Data
Aug. 15, 2002 (DE) 202 12 802.4

(51) Int. Cl. B67D 5/42; B65D 35/28

(52) U.S. Cl. 222/386.5; 222/95

(57) ABSTRACT

A discharge valve for discharge of pressurized fluid, foam, gel or similar materials includes a sack made out of flexible film material, which is flat welded in a border area in two superimposed layers and a receptacle body, the body being welded in the border area between the two layers of the film material. The valve further includes a valve stem, which is made of an essentially impermeable synthetic material to organic media and has a tubular section, whereby the receptacle body has either a tubular appendage or a corresponding receptacle and the valve stem has either an appendage or receptacle as counterpart for the receptacle body in order to connect the receptacle body and the valve stem with each other using a clamp connection. A gasket arranged between the receptacle body and valve stem at least partially covers the receptacle body on its side facing the valve stem.

The invention relates to a discharge valve provided with a sack for the dispensing of pressurized fluid, foam, gel or similar.

From WO 90/10583 a chamber container is known in which a flexible inner sack holds chemicals which generate pressurized gas. The inner sack consists of a multilayer synthetic film with exterior aluminum lamination. The inner layer of the film is made of polyolefins. The sack is directly welded to the valve stem, which is also made of polyolefin. Polyolefins exhibit the property to be permeable to organic media. If an organic medium such as butane is used as a pressurizing agent to compress the sack, with the use of polyolefins for the valve stem a pressure equilibrium occurs between the sack and the container contents through diffusion. It also turned out that a solvent can diffuse out of the sack through the valve stem.

From EP 0 697 348 B1 a unit is known consisting of a discharge valve and a sack welded with it. In this unit the valve stem is not made of a synthetic which is weldable with polyolefins, but rather a synthetic material which is impermeable to organic media is used. The sack is attached to the valve stem using a mechanical clamping device. Here the sack is held in a non-welded, folded border area with an opening through which protrudes an extension body with a tubular appendage arranged in the sack. The extension body is welded in the sack with the inner side of the sack. Extension body and valve stem are engaged together. Such a discharge valve with an extension body welded in the sack gives rise to increased manufacturing and assembly expenditures.

From EP 0 471 503 a discharge valve is known with a sack in which an extension piece is arranged within the sack in a folded border area. The extension body is held onto the sack using a clamping ring arranged on the exterior of the valve sack. A second clamping device fastens the extension body with the valve stem. Here also the large number of parts gives rise to increased manufacturing and assembly expenditures.

It is an object of the invention to create a discharge valve provided with a sack which is impermeable to organic media and with which the sack can be fastened to the valve stem securely and easily from a manufacturing and assembly standpoint.

According to the invention the object is solved by a discharge valve with the features from Claim 1 or from Claim 16. Favorable designs make up the subject matter of the subclaims.

The discharge valve according to the invention according to Claim 1 is joined with a sack and serves to discharge pressurized fluid, foam, gel or similar. The sack is made of a flexible film material and at least in one border area is flat welded in two superimposed layers. Also the valve has a receptacle body which is welded in the border area between the layers of the film material. The valve stem of the discharge valve is made of a synthetic material which is essentially impermeable to organic media and has a tubular section. Receptacle body and valve stem have either a tubular appendage or a corresponding receptacle for this, which, if the receptacle body has an appendage, the valve stem has the corresponding receptacle and, if the valve stem has the appendage, the receptacle body is provided with the corresponding receptacle. The receptacle body and the valve stem are connected with each other using a clamp connection which is preferably designed as a snap or latch connection. Here it is initially irrelevant whether the tubular appendage is formed on the valve stem or on the receptacle body. The clamping connection between these bodies is made in that the tubular appendage is inserted into the receptacle and fastened in it. Additionally a gasket is arranged between the receptacle body and the valve stem. The gasket at least partially covers the receptacle body on the side facing the valve stem. The discharge valve according to the invention is easy to assemble with its few parts. Furthermore it is sufficiently sealed by the use of a valve stem which is impermeable to organic media and by the gasket. The receptacle body, which is weldable with the film material of the sack, is normally manufactured out of a material permeable to organic media. The diffusion of the organic media is prevented by the gasket between the receptacle body and the valve stem, whereby a pressure equilibrium is stopped and a sealing is achieved.

In a possible embodiment the appendage has a tubular section, which opens out into a widened end section. The end section is preferably designed truncated and narrows down to the free end of the appendage. The corresponding receptacle has a smaller diameter in its opening section than in a section distanced from the opening. In the connected condition the widened end section of the appendage locks to the step in the receptacle.

Preferably the gasket has the shape of a flat ring and is manufactured out of a flexible material. Preferably a BUNA®, which possesses elastic properties and prevents a diffusion of organic media, is used as the material for the gasket. Preferably a synthetic BUNA N is used.

The receptacle body has a circumferential, tapered ring on its bearing surface. In the assembled condition the gasket is pressed onto the ring so that the effectiveness of the sealing is increased.

The receptacle body has a tapered-oval cross section whose tapers point to the bearing surfaces of the layers of the sack. The tapered-oval receptacle body extends its longitudinal direction along the sack edge. The receptacle body ends approximately even with the sack edge, so that the receptacle body is sealed on the side and has a tapered-oval, free lying top side, which points to the valve stem. The gasket at least partially covers these surfaces.

In a possible design the appendage is formed onto the valve stem and the receptacle body is provided with the receptacle. An alternative is also possible that the appendage is formed onto the receptacle body and the receptacle for the appendage is provided in the valve stem. The welded side of the film material is coated with PE, PP and/or PET. The receptacle body which is weldable with the film material is made out of PBT, PE or PT, whereby preferably PBT and PET, PE and PE as well as PT and PT are used for a welded connection. The valve housing is preferably made of POM, especially polyacetal, which is impermeable to organic media.

Heat welding as well as ultrasonic welding is suitable for the bonding of the receptacle body and film material.

Two preferable embodiments of the invention are described subsequently in more detail based on the figures, wherein

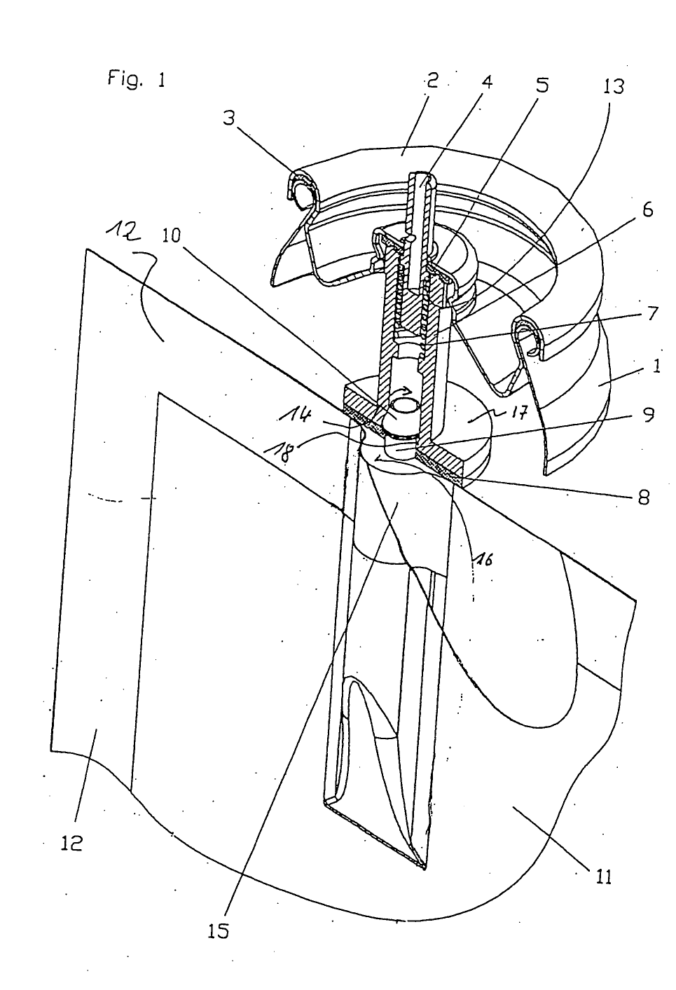

FIG. 1 shows a perspective view of a discharge valve provided with a sack in an aerosol can in axial cross section, in which the appendage is formed to the receptacle body and

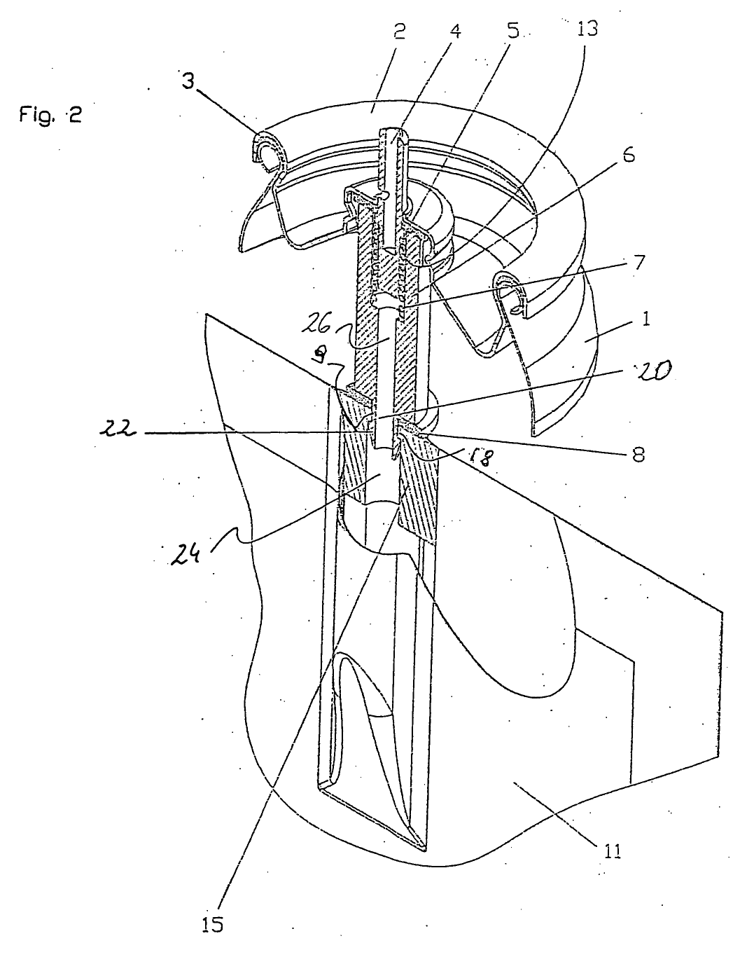

FIG. 2 shows a perspective view of a discharge valve provided with a sack in an aerosol can in axial section, in which the appendage is formed to the valve stem, and

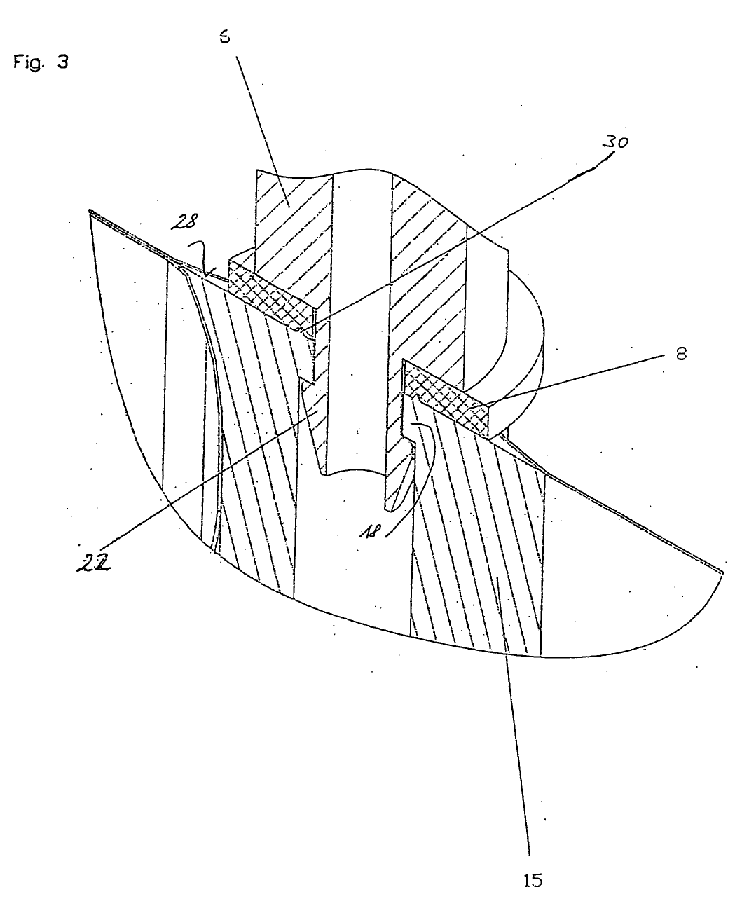

FIG. 3 shows an enlarged, perspective view of the connection of the receptacle body and valve stem for the discharge valve from FIG. 2.

The diagrammed discharge valve provided with a sack contains a valve cap 2, which is crimped with the container 1 in a known manner, whereby a flexible seal 3, preferably made of synthetic rubber Buna N which is essentially impermeable to propellants, is provided between the container 1 with the valve cap 2. The container 1 has an opening on its top end crimped with the valve cap 2 through which the sack 11 is introduced into the container 1. The valve cap 2 accommodates a valve stem 6 which is sealed against the valve cap 2 by a flexible washer 5, whereby a valve needle 4 is arranged in the valve stem 6, which presses axially through a spring 7 against the flexible washer 5 using the support surface 13 on the valve needle 4 and therefore keeps the discharge valve in the closed initial position. The valve needle 4 can be activated from outside, so that the valve needle 4 is moved against the effect of a spring 7 in the axial direction in the valve stem 6 from a closed into an open position and vice versa. The spring 7 is supported on a seat in the lower area of the valve stem 6 and on the valve needle 4 itself.

The sack 11, which consists of a laminate of preferably nylon or polyester as outer layer, aluminum film as middle layer and polyethylene film as inner layer, is closed in the non-folded border areas using welding seams 12, whereby in the welding seam 12 on sack 11 the receptacle body 15, which is extended into the sack 11, is gastight welded. The receptacle body 15 can be made of the easy-to-weld polyolefin or of another material able to be welded with the sack

On the valve stem 6 is found a receptacle 14 on the opposite side from the valve cap 2, which cylindrically designed receives an appendage 10 of the receptacle body 15 which is welded in the sack 11 for fastening onto the valve stem 6. At least one gasket 8 is arranged between the receptacle 14 and the welded receptacle body 15. The gasket 8 in the variation diagrammed in FIG. 1 covers the entire frontal surface 16 of the welded receptacle body 15. The truncated shaped end area 10 of the appendage 9 and the receptacle 14 are preferably designed as a clip connection, which the gasket 8 pinches in the axial direction between the receptacle 14 and the frontal surface 16 of the welded receptacle body 15, so that the frontal surface 16 is closed gastight with the connected appendage 10. Consequently the valve stem 6 which is impermeable to organic media encloses the receptacle body 15 which is welded in the sack 11 by means of the receptacle 14 and the gasket 8. The attachment area of the valve stem is enlarged by a circumferential flange 17. The gasket 8 is designed as a flat circumferential ring around the appendage 9. The receptacle 14 has a step 18 with a narrowed cross section, which in the connected condition is locked by the appendage.

The sack 11 extends essentially over the entire length of the interior of the container 1.

The sack contents such as liquid, foam, gel or similar and the pressure gas, such as environmentally friendly butane, for example as container contents, are filled using the discharge valve in a known manner into the sack 11 or into the container 1. At the same time the sack 11 in the container 1 expands and takes Lip a significant portion of the container volume. When emptying the sack 11 the valve needle 4 is pressed down against the force of the spring 7 so that the sack contents are pressed out under expansion of the pressure gas in the container 1, namely through the valve needle 4. The discharge valve, depending on the requirements, can involve the known metering valves, tip valves or, as is here diagrammed in FIG. 1, the continuous spray valves.

FIG. 2 shows an alternative embodiment in which the same elements are provided with the same reference numbers. The valve stem 6 has a formed appendage 9, which has a tubular section 20 with a truncated shaped end Section 22. The tapered-oval receptacle body 15 has a central bore 24, which is connected with the discharge duct 26 of the valve stem 6. The central bore 24 has a circumferential step 18 on the end facing the valve stem, which narrows the cross section of the bore 24. The section 22 of the appendage 20 latches into the connection position by the step 18, whereby a force is exerted on the gasket.

The Gasket 8 essentially covers the Surface 28 of the Receptacle Body 15 facing the valve stem. Only a triangular, acute angle area of the Receptacle Body 15 protrudes above the Gasket 8.

The Receptacle Body 15 has a circumferential, tapered Ring 30, which presses against the Gasket 8, which additionally seals the connection. In the diagrammed example the Valve Stem 6 is made of POM, the Receptacle Body 15 of PE, which is weldable with an inner layer of the sack made of PE.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A discharge valve for discharge of pressurized fluids, foam, gel or similar materials, comprising:
a sack of flexible film material, said sack being flat welded in a border area in two superimposed layers;
a receptacle body which is welded in the border area between the two layers of the film material;
a valve stem which is made of a synthetic material that is essentially impermeable to organic media and includes a tubular section, the receptacle body having one of a tubular appendage and a corresponding receptacle and the valve stem having one of an appendage and a receptacle as a counterpart for the receptacle body, in order to connect the receptacle body and valve stem with each other using a clamp connection; and
a gasket is arranged between the receptacle body and valve stem, said gasket at least partially covering the receptacle body on its side facing the valve stem.

22. A discharge valve according to claim 21, wherein the appendage has a tubular section with a widened end section.

23. A discharge valve according to claim 22, wherein the end section narrows in a truncated shape towards its free end.

24. A discharge valve according to claim 21, wherein the receptacle has a step in its opening section that reduces the diameter.

25. A discharge valve according to claim 21, wherein the gasket has the shape of a flat ring.

26. A discharge valve according to claim 25, wherein the gasket is made of a flexible material, preferably out of a BUNA.

27. A discharge valve according to claim 21, wherein the receptacle body has a circumferential tapered ring on its side facing the valve stem.

28. A discharge valve according to claim 21, wherein the receptacle body has a tapered-oval cross section, whose tips point to the welding seam of the sack.

29. A discharge valve according to claim 21, wherein the gasket is pressed between the valve stem and the receptacle body, in the connected condition therebetween.

30. A discharge valve according to claim 21, wherein the appendage is formed on the valve stem and the receptacle body is provided with the receptacle.

31. A discharge valve according to claim 21, wherein the appendage is formed on the receptacle body and the receptacle is provided in the valve stem.

32. A discharge valve according to claim 21, wherein the film material is coated on its welded side with at least one of PE, PET and PP.

33. A discharge valve according to claim 32, wherein the receptacle body is made out of one of PBT, PE and PP.

34. A discharge valve according to claim 32, wherein the receptacle body and the welded side of the film material is made out of one of the following material combinations: PBT and PET, PE and PE, and PP and PP.

35. A discharge valve according to claim 21, wherein the valve housing is made out of POM, especially polyacetals.

36. A discharge valve with a sack for the discharge of pressurized fluids, foams, gels or similar materials comprising:
a welded sack made from a flexible film material;
a receptacle body welded in said sack which is able to be placed into a container through an opening which is closable by a valve cap whereby the valve cap holds a valve stem with a valve needle which is axially movable out of a closed position against the force of an elastic element, wherein a receptacle is arranged on a valve stem for fastening of a sack wherein a frontal surface of the receptacle body welded in the sack is at least partially covered by a gasket.

37. A discharge valve with a sack according to claim 36, wherein the gasket is arranged between the frontal surface of the receptacle body and the receptacle of the valve stem.

38. A discharge valve with a sack according to claim 36, wherein the receptacle body has an appendage which is held by the valve stem for fastening on the valve stem.

39. A discharge valve with a sack according to claim 36, wherein the width of the welding seams on the sack is at least 5 mm to increase the diffusion resistance.

40. A discharge valve according to claim 39, wherein the width of the welding seam is approximately 10 to 14 mm.

41. A discharge valve according to claim 36, wherein the elastic element is a spring.
